(19) United States
(12) Patent Application Publication
(10) Pub. No.: US 2014/0356733 A1
(43) Pub. Date: Dec. 4, 2014

(54) ADDITIVE FOR LITHIUM BATTERY ELECTROLYTE, ORGANIC ELECTROLYTE SOLUTION INCLUDING THE SAME AND LITHIUM BATTERY USING THE ELECTROLYTE SOLUTION

(71) Applicant: Samsung SDI Co., Ltd., Yongin-si (KR)

(72) Inventors: Makhmut Khasanov, Yongin-si (KR); Woo-Cheol Shin, Yongin-si (KR); Vladimir Egorov, Yongin-si (KR); Pavel Alexandrovich Shatunov, Yongin-si (KR); Denis Chernyshov, Yongin-si (KR); Sang-Hoon Kim, Yongin-si (KR); Ha-Rim Lee, Yongin-si (KR); In-Haeng Cho, Yongin-si (KR); Alexey Tereshchenko, Yongin-si (KR)

(73) Assignee: Samsung SDI Co., Ltd., Yongin-si (KR)

(21) Appl. No.: 14/269,946

(22) Filed: May 5, 2014

(30) Foreign Application Priority Data
May 28, 2013 (KR) 10-2013-0060609

(51) Int. Cl. H01M 10/0567; H01M 10/0525; H01M 10/0569

(52) U.S. Cl. CPC H01M 10/0567; H01M 10/0569; H01M 10/0525
USPC 429/331; 429/188; 429/200; 429/342; 429/338; 429/341; 429/337; 429/339; 429/336; 429/343; 429/326; 429/329; 429/332; 429/334; 549/229

(57) ABSTRACT

Provided are an additive for a lithium battery electrolyte, wherein the additive is an ethylene carbonate based compound represented by the following Formula 1 or 2, an organic electrolyte solution including the additive, and a lithium battery including the organic electrolyte solution:

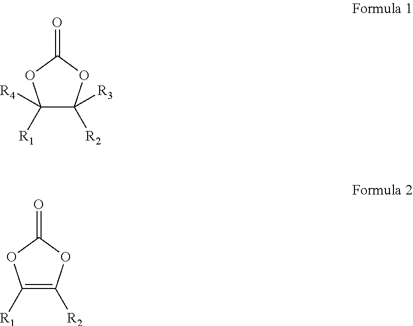

in the above Formulae,
R₁, R₂, R₃, and R₄ are each independently a non-polar functional group or a polar functional group, the polar functional group including a heteroatom belonging to groups 13 to 16 of the periodic table of elements, and
one or more of R₁, R₂, R₃, and R₄ are the polar functional groups.

### CROSS-REFERENCE TO RELATED APPLICATIONS

This application claims the benefit of Korean Patent Application No. 10-2013-0060609, filed on May 28, 2013 in the Korean Intellectual Characteristic Office, the disclosure of which is incorporated herein in its entirety by reference.

### BACKGROUND

1. Field

One or more embodiments relate to additives for lithium battery electrolytes, organic electrolyte solutions including the additives, and lithium batteries using the electrolyte solutions.

2. Description of the Related Technology

Lithium batteries are used as power supplies for driving portable electronic devices such as video cameras, mobile phones, and laptop computers. Lithium secondary batteries are rechargeable, have energy densities per unit weight that are about three times or greater than that of conventional lead storage batteries, nickel-cadmium batteries, nickel-hydride batteries, nickel-zinc batteries, and the like, and may be quickly charged.

The lithium batteries operate at high driving voltages and thus, aqueous electrolyte solutions that are highly reactive with lithium may not be used in the lithium batteries. Organic electrolyte solutions are generally used in the lithium batteries. Lithium salts are dissolved in organic solvents to prepare organic electrolyte solutions. The organic solvents that are stable at high voltages and have high ion conductivity and permittivity, and low viscosity are preferable.

When a carbonate-based polar non-aqueous solvent is used in a lithium battery, a side reaction occurs during an initial charge between a carbon acting as an anode and an electrolyte solution, thereby causing an irreversible reaction that uses an excessive amount of charges. As a result of the irreversible reaction, a passivation layer such as a solid electrolyte interface (SEI) is formed on a surface of an anode. The SEI prevents decomposition of the electrolyte solution during a charge/discharge and acts as an ion tunnel. As the SEI has higher stability and lower resistance, the lifespan and capacity of the lithium battery may increase.

Accordingly, an organic electrolyte solution capable of forming an SEI having improved stability and low resistance is required.

### SUMMARY

One or more embodiments include additives for new lithium battery electrolytes.

One or more embodiments include organic electrolyte solutions including the additives.

One or more embodiments include lithium batteries including the organic electrolyte solutions.

Additional aspects will be set forth in part in the description which follows and, in part, will be apparent from the description, or may be learned by practice of the presented embodiments.

According to an aspect of the present embodiments, there is provided an additive for a lithium battery electrolyte, which is an ethylene carbonate based compound represented by Formula 1 or 2 below:

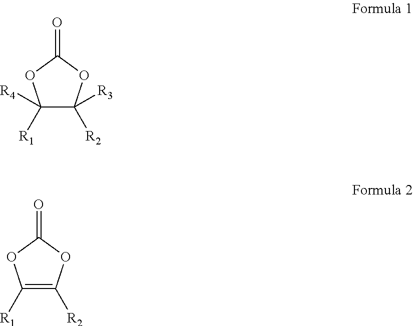

in the above Formulae,

R₁, R₂, R₃, and R₄ are each independently a non-polar functional group or a polar functional group, the polar functional group including a heteroatom belonging to groups 13 to 16 of the periodic table of elements, and

one or more of R₁, R₂, R₃, and R₄ are the polar functional groups.

According to another aspect of the present embodiments, there is provided an organic electrolyte solution including:

a lithium salt;

an organic solvent; and

the additive according to the above.

According to another aspect of the present embodiments, there is provided a lithium battery including:

a cathode;

an anode; and

the organic electrolyte solution according to the above.

### BRIEF DESCRIPTION OF THE DRAWINGS

These and/or other aspects will become apparent and more readily appreciated from the following description of the embodiments, taken in conjunction with the accompanying drawings of which:

FIG. 1 is a graph showing capacity retention rates of the lithium batteries manufactured in Examples 11 to 13, and Comparative Example 5;

FIG. 2 is a graph showing initial charge/discharge profiles of the lithium batteries manufactured in Example 17 and Comparative Example 7; and

FIG. 3 is a graph showing a capacity retention rate of the lithium battery manufactured in Example 17;

FIG. 4 is a graph showing a capacity retention rate of the lithium battery manufactured in Example 18;

FIG. 5 is a differential capacity curve of the lithium batteries manufactured in Examples 19 and 20, and Comparative Example 8; and

FIG. 6 is a schematic view of a lithium battery according to an example embodiment.

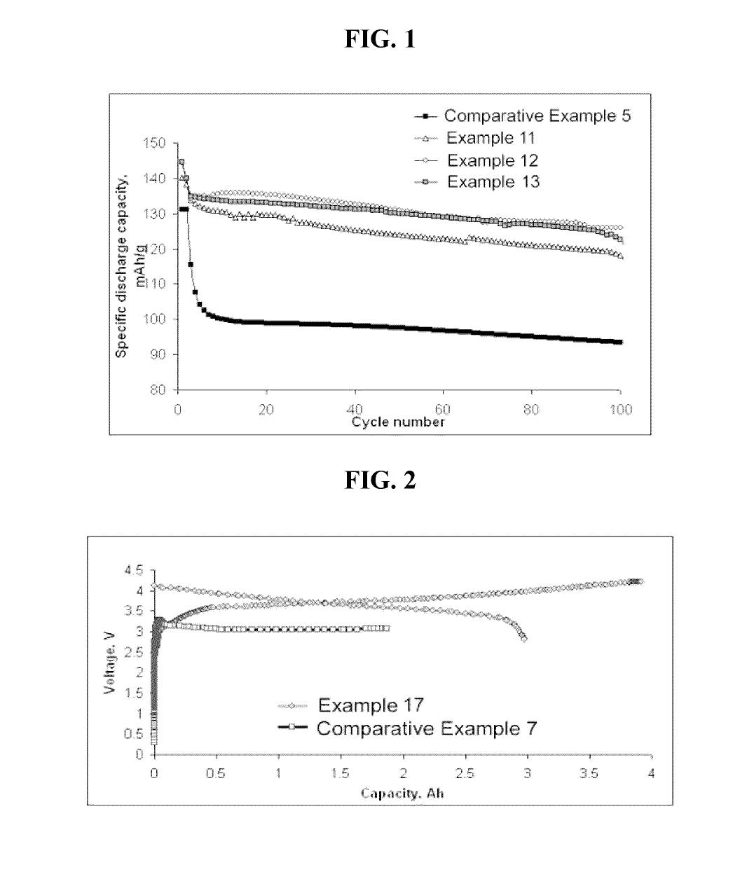

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

Hereinafter, an additive for a lithium battery electrolyte, an organic electrolyte solution including the additive, and a lithium battery using the organic electrolyte solution according to example embodiments will be described in detail.

An additive for a lithium secondary battery electrolyte according to an embodiment is an ethylene carbonate based compound represented by Formula 1 or 2 below:

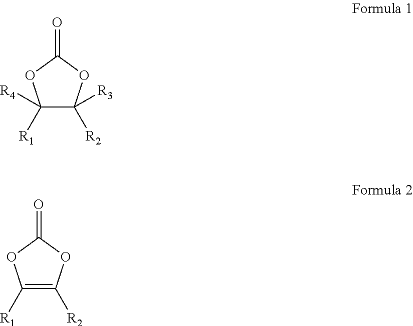

In Formulae above, R₁, R₂, R₃, and R₄ are each independently a non-polar functional group or a polar functional group including a heteroatom belonging to groups 13 to 16 of the periodic table of elements, and one or more of R₁, R₂, R₃, and R₄ are the polar functional groups.

The additive that is an ethylene carbonate based compound may be added to a lithium battery electrolyte to improve battery performance such as a discharge capacity and a lifespan characteristic.

The reasons for the improvement in the performance of a lithium battery upon the addition of the ethylene carbonate based compound to an electrolyte solution will be described in greater detail; however, this is only to facilitate the understanding of the present embodiments and thus, the scope of the present embodiments is not limited to the range described below.

The ethylene carbonate based compound accepts electrons from a surface of a negative electrode during a first charging process to be reduced or reacts with pre-reduced polar solvent molecules to affect properties of a solid electrolyte interface (SEI) formed on the surface of the negative electrode. The ethylene carbonate based compound may accept electrons more easily from the anode than a polar solvent. Hence, the ethylene carbonate based compound may be reduced at lower voltage than the polar solvent such that the ethylene carbonate based compound is reduced before the polar solvent is reduced.

For example, the ethylene carbonate based compound can include an additional polar functional group other than an ethylene carbonate ring to be more easily reduced and/or decomposed into radicals and/or ions during a charge. Accordingly, the radical and/or the ion may bond with a lithium ion to form an insoluble compound and precipitate on a surface of an electrode, or additionally react with a solvent to facilitate forming an additional insoluble compound. The insoluble compound may for example react with various functional groups on a surface of a carbon-based anode or with the carbon-based anode itself to form a covalent bond, or be adsorbed on a surface of an electrode. As a result of the bonding and/or adsorption, a modified SEI having improved stability may be formed, which remains more stable even after a long period of charge and discharge than an SEI formed only using an organic solvent. Also, the modified SEI having improved stability may prevent an organic solvent in which the lithium ions are dissolved from entering into an electrode during an intercalation of the lithium ions more effectively. Accordingly, the modified SEI prevents a direct contact between the organic solvent and the anode more effectively to further improve reversibility of intercalation/deintercalation of the lithium ions, and ultimately increase a discharge capacity of a battery and improve a lifespan characteristic.

In the ethylene carbonate based compound of Formulae 1 and 2, the polar functional group may include one or more of heteroatoms selected from the group consisting of oxygen, nitrogen, phosphorus, sulfur, silicon, and boron.

For example, a polar functional group of the ethylene carbonate based compound of Formula 1 and 2 includes one or more selected from the group consisting of —C(═O)OR⁹, —OC(═O)R⁹, —OR⁹, —OC(═O)OR⁹, —R⁸OC(═O)OR⁹, —C(═O)R⁹, —R⁸C(═O)R⁹, R⁸OC(═O)R⁹, —C(═O)—O—C(═O)R⁹, —R⁸C(═O)—O—C(═O)R⁹, —SR⁹, —R⁸SR⁹, —SSR⁸, —R⁸SSR⁹, —S(═O)R⁹, —R⁸S(═O)R⁹, —R⁸C(═S)R⁹, —R⁸C(═S)SR⁹, SO₃R⁹, —SO₃R⁹, —NNC(═S)R⁹, —R⁸NNC(═S)R⁹,

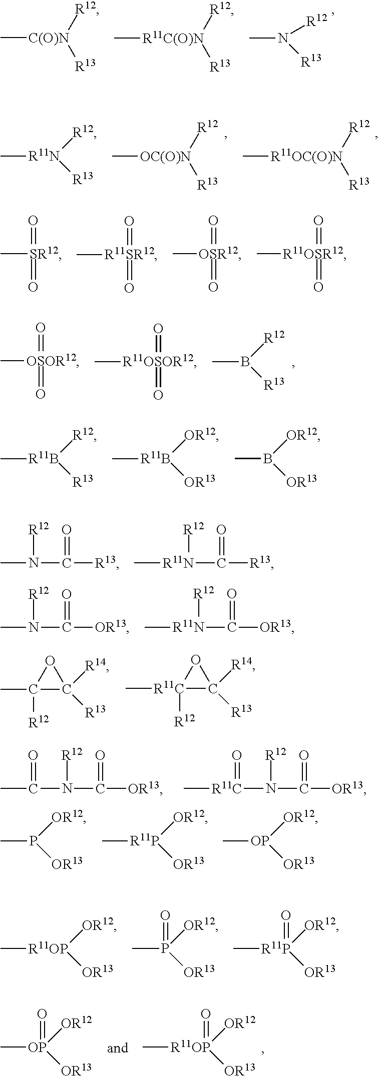

wherein

R⁸ and R¹¹ are each independently a C₁-C₂₀ linear or branched alkylene group substituted or unsubstituted with halogen; a C₂-C₂₀ linear or branched alkenylene group substituted or unsubstituted with halogen; a C₂-C₂₀ alkynylene group substituted or unsubstituted with halogen; a C₃-C₁₂ cycloalkylene group substituted or unsubstituted with halogen; a C₆-C₄₀ arylene group substituted or unsubstituted with halogen; or a C₇-C₁₅ aralkylene group substituted or unsubstituted with halogen,

R⁹, R¹², R₁₃ and R¹⁴ are each independently hydrogen; a C₁-C₂₀ linear or branched alkyl group substituted or unsubstituted with halogen; a C₂-C₂₀ linear or branched alkenyl group substituted or unsubstituted with halogen; a C₂-C₂₀ alkynyl group substituted or unsubstituted with halogen; a C₃-C₁₂ cycloalkyl group substituted or unsubstituted with halogen; a C₆-C₄₀ aryl group substituted or unsubstituted with halogen; or a C₇-C₁₅ aralkyl group substituted or unsubstituted with halogen.

For example, a polar function group of the ethylene carbonate based compound of the above Formulae 1 and 2 includes one or more selected from the group consisting of —C(═O)OR¹⁵, —OC(═O)R¹⁵, —OR¹⁵, —OC(═O)OR¹⁵, —R¹⁶OC(═O)OR¹⁵, —C(═O)R¹⁵, —R¹⁶C(═O)R¹⁵, —OC(═O)R¹⁵, —R¹⁶OC(═O)R¹⁵, —C(═O)—O—C(═O)R¹⁵, and —R¹⁶C(═O)—O—C(═O)R¹⁵, wherein R¹⁶ is a C1-C10 linear or branched alkylene group substituted or unsubstituted with halogen, R¹⁵ is hydrogen; a C1-C10 linear or branched alkyl group substituted or unsubstituted with halogen.

For example, the ethylene carbonate based compound may be represented by Formula 3 or 4 below:

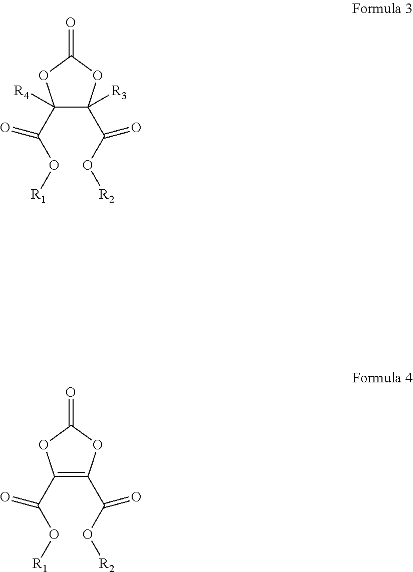

In the above Formulae, R₁ and R₂ are each independently a C1-C10 linear or branched alkyl group substituted or unsubstituted with halogen, R₃ and R₄ are each independently hydrogen; a C1-C10 linear or branched alkyl group substituted or unsubstituted with halogen; or R₁₆OC(═O)—, and R₁₆ is a C1-C10 linear or branched alkyl group substituted or unsubstituted with halogen.

For example, in Formulae 3 and 4, R₁, R₂, R₃, and R₄ are each independently hydrogen, a methyl group, an ethyl group, a propyl group, an isopropyl group, an n-butyl group, a tert-butyl group, a pentyl group, a hexyl group, a heptyl group, an octyl group, a nonyl group, and a decyl group.

For example, the ethylene carbonate based compound may be represented by one of Formulae 5 to 10 below:

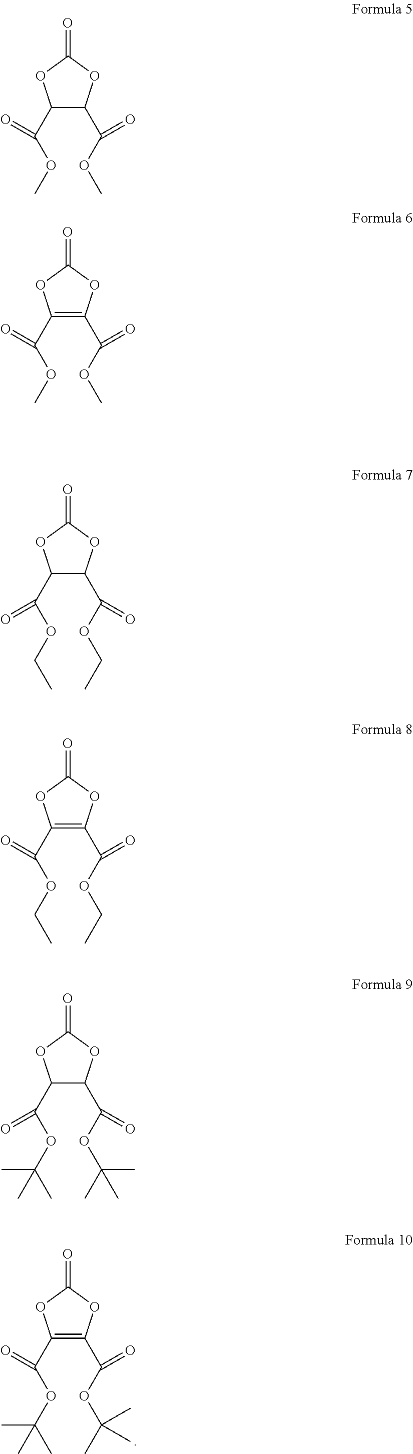

An organic electrolyte solution according to another embodiment includes a lithium salt; an organic solvent; and an ethylene carbonate based compound, which is an additive according to the description above.

The content of the ethylene carbonate based compound, which is an additive in the organic electrolyte solution, may be about 0.1 wt % to about 10 wt % based on a total weight of the organic electrolyte solution; however, the content is not limited to this range and a suitable amount may be used as needed. Battery characteristics may be further improved in the above content range.

The organic solvent in the organic electrolyte solution may include a low boiling point solvent. The low boiling point solvent refers to a solvent having a boiling point of about 200° C. or less at an atmospheric pressure.

For example, the organic solvent may include one or more selected from the group consisting of a dialkyl carbonate, cyclic carbonate, a linear or a cyclic ester, a linear or a cyclic amide, an aliphatic nitrile, a linear or a cyclic ether, and derivatives thereof.

In greater detail, the organic solvent may include one or more selected from the group consisting of dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), fluoro-ethylene carbonate (FEC), butylene carbonate, ethyl propionate, ethyl butyrate, acetonitrile, succinonitrile (SN), dimethyl sulfoxide, dimethylformamide, dimethylacetamide, gamma-valerolactone, gamma-butyrolactone, and tetrahydrofuran; however, the organic solvent is not limited thereto and any low boiling point solvent used in the art may be used.

For example, the organic solvent may include propylene carbonate, which has high ion conductivity.

A concentration of the lithium salt in the organic electrolyte solution may be about 0.01 M to about 2.0 M, but the concentration is not limited thereto and a suitable concentration may be used as needed. Battery characteristics may be further improved in the above concentration range.

The lithium salt used in the organic electrolyte solution is not limited and any lithium salt usable in the art may be used. For example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein, x and y are 1 to 20), LiCl, LiI, or a mixture thereof may be used.

The electrolyte solution may be in a liquid form or a gel form. A lithium salt and the above described additive may be added to the above described organic solvent to prepare the organic electrolyte solution.

A lithium battery according to another embodiment includes a cathode; an anode, and the electrolyte solution described above. The form of the lithium battery is not limited and includes lithium secondary batteries such as a lithium ion battery, a lithium ion polymer battery, and a lithium sulfur battery as well as a lithium metal battery.

For example, the lithium battery may be manufactured by the following method.

First, a cathode is prepared.

For example, a positive active material composition is prepared, in which a positive active material, a conducting agent, a binder, and a solvent are mixed. The positive active material composition is directly coated on a metal current collector to prepare a positive electrode plate. Alternatively, the positive active material composition is casted on a separate scaffold and then a film peeled off from the scaffold may be laminated on a metal current collector to prepare a positive electrode plate. The positive electrode plate is not limited to the forms listed above and may have a different form.

The positive active material is a lithium-containing metal oxide and any positive active material generally used in the art may be used. For example, one or more of composite oxides of lithium and a metal selected from, for example, cobalt, manganese, nickel, and a combination thereof may be used and more specifically, a compound represented by any one of the following Formulae LiₐA_{1-b}B_{b}D₂ (wherein, 0.90≦a≦1.8 and 0≦b≦0.5); LiₐE_{1-b}B_{b}O_{2-c}D_{c} (wherein, 0.90≦a≦1.8 and 0≦b≦0.5, 0≦c≦0.05); LiE_{2-b}B_{b}O_{4-c}D_{c} (wherein, 0≦b≦0.5 and 0≦c≦0.05); LiₐNi_{1-b-c}Co_{b}B_{c}D_{α} (wherein, 0.90≦a≦1.8, 0≦b≦0.5, 0≦c≦0.05, and 0≦α≦2); LiₐNi_{1-b-c}Co_{b}B_{c}O_{2-α}F_{α} (wherein, 0.90≦a≦1.8, 0≦b≦0.5, and 0≦c≦0.05, 0≦α<2); LiₐNi_{1-b-c}Co_{b}B_{c}O_{2-α}F₂ (wherein, 0.90≦a≦1.8, 0≦b≦0.5, and 0≦c≦0.05, 0<α<2); LiₐNi_{1-b-c}Mn_{b}B_{c}D_{α} (wherein, 0.90≦a≦1.8, 0≦b≦0.5, and 023 c≦0.05, 0<α≦2); LiₐNi_{1-b-c}Mn_{b}B_{c}O_{2-α}F_{α} (wherein, 0.90≦a≦1.8, 0≦b≦0.5, 0≦c≦0.05, and 0<α<2); LiₐNi_{1-b-c}Mn_{b}B_{c}O_{2-α}F₂ (wherein, 0.90≦a≦1.8, 0≦b≦0.5, and 0≦c≦0.05, 0<α<2); LiₐNi_{b}E_{c}G_{d}O₂ (wherein, 0.90≦a≦1.8, 0≦b≦0.9, and 0≦c≦0.5, 0.001≦d≦0.1); LiₐNi_{b}Co_{c}Mn_{d}GeO₂ (wherein, 0.90≦a≦1.8, 0≦b≦0.9, 0≦c≦0.5, and 0≦d≦0.5, 0.001≦e≦0.1); LiₐNiG_{b}O₂ (wherein, 0.90≦a≦1.8, and 0.001≦b≦0.1); LiₐCoG_{b}O₂ (wherein, 0.90≦a≦1.8 and 0.001≦b≦0.1); LiₐMnG_{b}O₂ (wherein, 0.90≦a≦1.8 and 0.001≦b≦0.1); LiₐMn₂G_{b}O₄ (wherein, 0.90≦a≦1.8 and 0.001≦b≦0.1); QO₂; QS₂; LiQS₂; V₂O₅; LiV₂O₅; LiIO₂; LiNiVO₄; Li(_{3-f)}J₂(PO₄)₃(0≦f≦2); Li_{(3-f)}Fe₂(PO₄)₃(0≦f≦2); and LiFePO₄ may be used.

In Formulae above, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; J is V, Cr, Mn, Co, Ni, Cu, or a combination thereof.

For example, LiCoO₂, LiMnₓO₂ₓ(x=1, 2), LiNi₁₋ₓMnₓO₂ₓ(0<x<1), LiNi_{1-x-y}CoₓMn_{y}O₂ (0≦x≦0.5, 0≦y≦0.5), and LiFePO₄ may be used.

Furthermore, the compounds listed above as positive active material may have a surface coating layer (hereafter, “coating layer”). Alternatively, a mixture of a compound without coating layer and a compound having a coating layer, the compounds being selected from the compounds listed above, may be used. The coating layer may include a coating element compound such as an oxide of a coating element, a hydroxide, an oxyhydroxide of a coating element, an oxycarbonate of a coating element, or a hydroxycarbonate of a coating element. The compounds included in the coating layer may be amorphous or crystallized. The coating element included in the coating layer may be Mg, Al, Co, K, Na, Ca, Si, Ti, V, Sn, Ge, Ga, B, As, Zr, or a mixture thereof. The process for forming the coating layer may be any coating method that coats by using the elements in the compounds described above and does not negatively affect the properties of the positive active materials (for example, spray coating or dipping method) and since this may be thoroughly understood by one or ordinary skill in the art, a detailed description of the method will be omitted.

Carbon black, graphite granules, or the like may be used as a conducting agent, but the conducting agent is not limited thereto and any conducting agent used in the art may be used.

A vinylidene fluoride/hexafluoropropylene copolymer, polyvinylidene fluoride (PVDF), polyacrylonitrile, polymethyl methacrylate, polytetrafluoroethylene, and a mixture thereof or a styrene-butadiene rubber based polymer may be used as the binder, but the binder is not limited thereto and any binder used in the art may be used.

N-methyl pyrrolidone, acetone, water, or the like may be used as the solvent, but the solvent is not limited thereto and any solvent used in the art may be used.

Contents of the positive active material, the conducting agent, the binder, and the solvent are the contents generally used in a lithium battery. One or more of the conducting agent, the binder, and the solvent may be omitted according to the use and the composition of a lithium battery.

Thereafter, a negative electrode is prepared.

For example, a negative active material, a conducting agent, a binder, and a solvent are mixed to prepare a negative active material composition. The negative active material composition is directly coated and dried on a metal current collector to prepare a negative electrode plate. Alternatively, the negative active material composition is casted on a separate scaffold and a film peeled off from the scaffold may be laminated on the metal current collector to prepare a negative electrode plate.

The negative active material may be any negative active material of a lithium battery used in the art. For example, the negative active material may include one or more selected from the group consisting of a lithium metal, a metal that is alloyable with lithium, a transition metal oxide, a non-transition metal oxide, and a carbon-based material.

For example, the metal alloyable with the lithium may be Si, Sn, Al, Ge, Pb, Bi, Sb, a Si—Y alloy (wherein Y is an alkali metal, an alkaline earth metal, a group 13 element, a group 14 element, a transition metal, a rare earth element, or a combination element thereof, except for Si), Sn—Y ally (wherein Y is an alkali metal, an alkaline earth metal, a group 13 element, a group 14 element, a transition metal, a rare earth element, or a combination element thereof, except for Sn). The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

For example, the transition metal oxide may be a lithium titanium oxide, a vanadium oxide, or a lithium vanadium oxide.

For example, the non-transition metal oxide may be SnO₂ or SiOₓ (0<x<2).

The carbon-based material may be a crystallized carbon, an amorphous carbon, or a mixture thereof. The crystallized carbon may be graphite such as natural graphite or artificial graphite in the form of amorphous, sheet, lean flakes, sphere, or fiber, and the amorphous carbon may be a soft carbon (low temperature calcination carbon), a hard carbon, a mesophase pitch carbon, or calcined coke.

The conducting agent and the binder in the negative electrode active material may be the same as those used in the positive electrode active material.

Contents of the negative active material, the conducting agent, the binder, and the solvent are the contents generally used in a lithium battery. One or more of the conducting agent, the binder, and the solvent may be omitted according to the use and the composition of the lithium battery.

Thereafter, a separator to be inserted between the cathode and the anode is prepared.

Any separator generally used in a lithium battery may be used. The separator may have low resistance to migration of ions in an electrolyte and have an excellent electrolyte-retaining capability. For example, the separator may be selected from a glass fiber, polyester, Teflon, polyethylene, polypropylene, polytetrafluoroethylene (PTFE), or a combination thereof, and may be a non-woven fabric or a woven fabric. For example, a rollable separator such as polyethylene and polypropylene is used in a lithium ion battery and a separator having excellent organic electrolyte solution impregnation capability may be used in a lithium ion polymer battery. For example, the separator may be prepared according to the following method.

A polymer resin, a filler, and a solvent are mixed to prepare a separator composition. The separator composition may be directly coated and dried on an electrode to form a separator. Alternatively, the separator composition is casted and dried on a scaffold and then a separator film peeled from the scaffold is laminated on an electrode to form a separator.

A polymer resin used for preparing the separator is not limited and all materials used for a binding material of an electrode plate may be used. For example, a vinylidene fluoride/hexafluoropropylene copolymer, polyvinylidene fluoride (PVDF), polyacrylonitrile, polymethylmethacrylate, or a mixture thereof may be used.

Thereafter, the organic electrolyte solution described above is prepared.

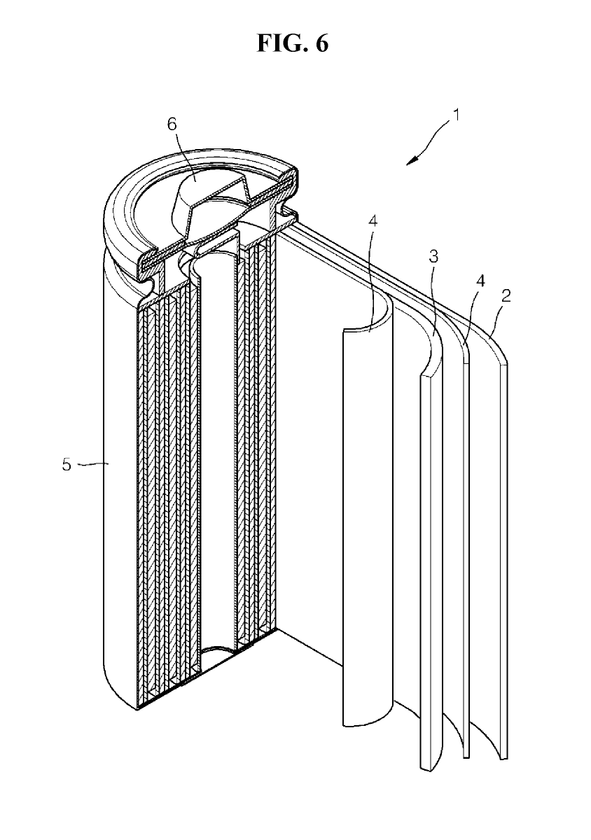

As shown in FIG. 6, a lithium battery 1 includes a cathode 3, an anode 2, and separators 4. The cathode 3, the anode 2, and the separators 4 described above are wound or folded to be enclosed in a battery case 5. Thereafter, an organic electrolyte solution is injected into the battery case 5, which is sealed by a cap assembly 6 to complete a lithium battery 1. The battery case 5 may be of a cylindrical type, a rectangular type, or a thin film type. For example, the lithium battery 1 may be a large thin film battery. The lithium battery 1 may be a lithium ion battery.

A separator 4 may be disposed between the cathode 3 and the anode 2 to form a battery structure. After the battery structure is layered in a bicelle structure, the battery structure is impregnated in an organic electrolyte solution, a resultant product therefrom is enclosed in a pouch and then sealed to complete a lithium ion polymer battery.

Also, a plurality of the battery structures is layered to form a battery pack and the battery pack may be used in all devices that require high capacity and high output. For example, the battery pack may be used in a laptop computer, a smart phone, and an electric vehicle (EV).

Also, the lithium batteries may be used in electric vehicles because of excellent lifespan characteristic and high-rate characteristic. For example, the lithium batteries may be used in hybrid vehicles such as plug-in hybrid electric vehicles (PHEV). Also, the lithium batteries may be used in fields that require a large amount of power storage such as electric bicycles and power tools.

Hereinafter, the present embodiments will be described in greater detail through Examples and Comparative Examples. However, the Examples are for illustrative purposes only and do not limit the scope of the claims.

### Preparing an Organic Electrolyte Solution

### EXAMPLE 1

1.0 M of LiPF₆ was used as a lithium salt and 1.0 wt % of dimethyl 2-oxo-1,3-dioxolane-4,5-dicarboxylate additive represented by the following Formula 5 based on a total weight of an organic electrolyte solution was added to ethyl methyl carbonate (EMC) to prepare an organic electrolyte solution.

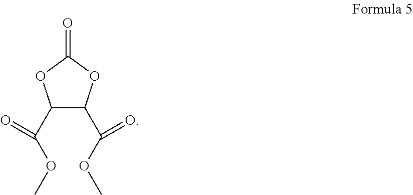

### EXAMPLE 2

An organic electrolyte solution was prepared in the same manner as in Example 1 except for changing the content of the dimethyl 2-oxo-1,3-dioxolane-4,5-dicarboxylate additive to 2.0 wt %.

### EXAMPLE 3

An organic electrolyte solution was prepared in the same manner as in Example 1 except for changing the content of the dimethyl 2-oxo-1,3-dioxolane-4,5-dicarboxylate additive to 5.0 wt %.

### EXAMPLE 4

1.0 M of LiPF₆ was used as a lithium salt and 1.0 wt % of dimethyl 2-oxo-1,3-dioxole-4,5-dicarboxylate additive represented by the following Formula 6 based on a total weight of an organic electrolyte solution was added to dimethyl carbonate (DMC) to prepare an organic electrolyte solution.

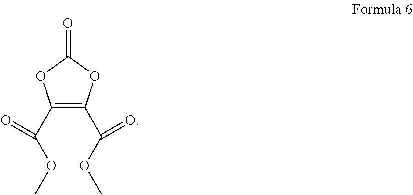

### EXAMPLE 5

An organic electrolyte solution was prepared in the same manner as in Example 4 except for changing the content of the dimethyl 2-oxo-1,3-dioxole-4,5-dicarboxylate additive to 2.0 wt %.

### EXAMPLE 6

An organic electrolyte solution was prepared in the same manner as in Example 4 except for changing the content of the dimethyl 2-oxo-1,3-dioxole-4,5-dicarboxylate additive to 5.0 wt %.

### EXAMPLE 7

1.0 M of LiPF₆ was used as a lithium salt and 5.0 wt % of dimethyl 2-oxo-1,3-dioxolane-4,5-dicarboxylate additive represented by the following Formula 5 based on a total weight of an organic electrolyte solution was added to a mixture solvent in which propylene carbonate (PC) and dimethyl carbonate (DMC) are mixed in a volume ratio of 1:1 to prepare an organic electrolyte solution.

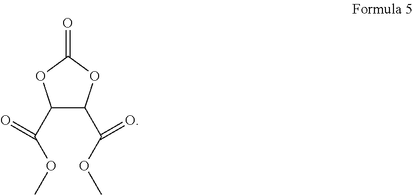

### EXAMPLE 8

1.0 M of LiPF₆ was used as a lithium salt and 5.0 wt % of dimethyl 2-oxo-1,3-dioxole-4,5-dicarboxylate additive represented by the following Formula 6 based on a total weight of an organic electrolyte solution was added to a mixture solvent in which propylene carbonate (PC) and dimethyl carbonate (DMC) are mixed in a volume ratio of 1:1 to prepare an organic electrolyte solution.

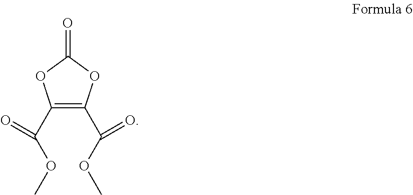

### EXAMPLE 9

1.3 M of LiPF₆ was used as a lithium salt and 1.0 wt % of dimethyl 2-oxo-1,3-dioxolane-4,5-dicarboxylate additive represented by the following Formula 5 based on a total weight of an organic electrolyte solution was added to a mixture solvent in which ethylene carbonate (EC), ethyl methyl carbonate (EMC), and dimethyl carbonate (DMC) are mixed in a volume ratio of 3:4:3 to prepare an organic electrolyte solution.

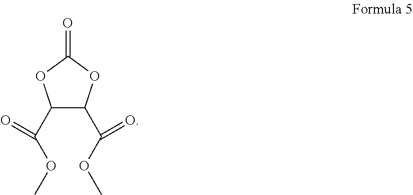

### EXAMPLE 10

An organic electrolyte solution was prepared in the same manner as in Example 9 except for changing the content of the dimethyl 2-oxo-1,3-dioxolane-4,5-dicarboxylate additive to 2.0 wt %.

### COMPARATIVE EXAMPLE 1

An organic electrolyte solution was prepared in the same manner as in Example 1 except for adding an additive represented by Formula 5.

### COMPARATIVE EXAMPLE 2

An organic electrolyte solution was prepared in the same manner as in Example 4 except for adding an additive represented by Formula 6.

### COMPARATIVE EXAMPLE 3

An organic electrolyte solution was prepared in the same manner as in Example 7 except for adding ethylene carbonate instead of the additive represented by Formula 5 in the same amount.

### COMPARATIVE EXAMPLE 4

An organic electrolyte solution was prepared in the same manner as in Example 9 except for adding an additive represented by Formula 5.

### Preparing a Lithium Battery

### EXAMPLE 11

### Preparing an Anode

97 wt % of graphite particles having an average diameter of 25 μm (C1SR, Japanese carbon), 1.5 wt % of styrene-butadienne rubber (SBR) binder (available from ZEON), and 1.5 wt % of carboxymethyl cellulose (CMC, available from NIPPON A&L) were mixed, introduced to distilled water, and agitated for 60 minutes by using a mechanical agitator to prepare a negative active material slurry. The slurry was coated in a thickness of about 60 μm on a copper current collector having a thickness of 10 on by using a doctor blade, dried for 0.5 hour in a hot wind dryer at a temperature of 100° C. and then vacuumed, dried again for 4 hours at a temperature of 120° C., and then roll pressed to prepare a negative electrode plate.

### Preparing a Cathode

97 wt % of LiNi_{1/3}Co_{1/3}Mn_{1/3}O₂, 1.5 wt % of carbon black powder (Denka black) as a conducting agent, and 1.5 wt % of polyvinylidene fluoride (PVdF, available from Solvay) were mixed and introduced to an N-methyl-2-pyrrolidone solvent, agitated for 30 minutes by using a mechanical agitator to prepare a positive active material slurry. The slurry was coated in a thickness of about 60 μm on an aluminum current collector having a thickness of 20 on by using a doctor blade, dried for 0.5 hour in a hot wind dryer at a temperature of 100° C. and then vacuumed, dried again for 4 hours at a temperature of 120° C., and then roll pressed to prepare a positive electrode plate.

A Polyethylene separator (available from Asahi Chemical, Star™ 20) having a thickness of 20 μm was used as a separator and the organic electrolyte solution prepared in Example 1 was used as an electrolyte solution to manufacture a coin cell according to a CR2016 standard.

### EXAMPLES 12 TO 20

A coin cell was manufactured in the same manner as in Example 11 except for using the organic electrolyte solution prepared in Examples 2 to 10 instead of the organic electrolyte solution prepared in Example 1.

### COMPARATIVE EXAMPLES 5 TO 8

A coin cell was manufactured in the same manner as in Example 11 except for using the organic electrolyte solution prepared in Comparative Examples 1 to 4 instead of the organic electrolyte solution prepared in Example 1.

### EVALUATION EXAMPLE 1

### Evaluation of Charge/Discharge Characteristics

The coin cells manufactured in Examples 11 to 20 and Comparative Examples 5 to 8 were each charged at a constant current of 0.2 C rate at a temperature of 25° C. to a voltage of 4.2 V, and then charged at a constant voltage of 4.2 V to a current of 0.05 C (cut-off current), followed by discharging with a constant current of 0.2 C rate until voltage reached 2.8 V (formation process, 1^{st} cycle).

Then, the coin cells each were charged at a constant current of 0.5 C rate at a temperature of 25° C. to a voltage of 4.2 V, and then charged at a constant voltage of 4.2 V to a current of 0.05 C (cut-off current), followed by discharging with a constant current of 0.5 C rate until voltage reached 2.8 V (with respect to Li) (formation process, 2^{nd} cycle)

After completing the 1^{st} to 2^{nd} cycles of the formation process, the lithium battery was charged at a constant current of 1.0 C rate at a temperature of 25° C. to a voltage of 4.2 V), and charged at a constant voltage of 4.2V to a constant current of 0.05 C (cut-off current), followed by discharging with a constant current of 1.0 C until the voltage reached 2.8 V. This cycle of charging and discharging was repeated 100 times.

Results of the charge/discharge experiments are shown in Table 1 below. A capacity retention rate at the 100^{th} cycle is denoted by the following Formula 1, wherein the 1^{st} cycle to 100^{th} cycle mean the charge-discharge cycles after completing the formation process.

Capacity retention rate=[discharge capacity at 100^{th} cycle/discharge capacity at 1^{st} cycle]×100 Formula 1

TABLE 1

| | Discharge capacity at | Capacity retention rate at |
|---|---|---|
| | 100^{th} cycle | 100^{th} cycle |
| Example 11 | 148.0 | 86.6% |
| Example 12 | 163.1 | 94.6% |
| Example 13 | 153.5 | 88.4% |
| Example 14 | 147.3 | 92.8% |
| Example 15 | 168.5 | 98.3% |
| Example 16 | 164.0 | 94.0% |
| Comparative | 120.6 | 80.9% |
| Example 5 | | |
| Comparative | 146.1 | 90.3% |
| Example 6 | | |

As shown in Table 1, the lithium batteries of Examples 11 to 16 including additives have substantially improved discharge capacities and lifespan characteristics than the lithium batteries of Comparative Examples 5 and 6 without the additives.

### EVALUATION EXAMPLE 2

### Evaluation of Initial Charge/Discharge Characteristics

The coin cells manufactured in Example 17 and Comparative Example 7 each were charged at constant current of 0.2 C rate at a temperature of 25° C. to voltage of 4.2 V, and then charged at a constant voltage of 4.2 V to a current of 0.05 C (cut-off current), followed by discharging with a constant current of 0.2 C until voltage reached 2.8 V to evaluate initial charge/discharge characteristics. The results of the charge/discharge are shown in FIG. 2.

As shown in FIG. 2, the lithium battery of Example 17 showed a stable charge/discharge graph; however, charge/discharge of the lithium battery of Comparative Example 7 was discontinued because negative electrode active materials were peeled off during a charge/discharge process.

Accordingly, it may be known that the additive of the present embodiments allows the formation of a more stable SEI than ethylene carbonate.

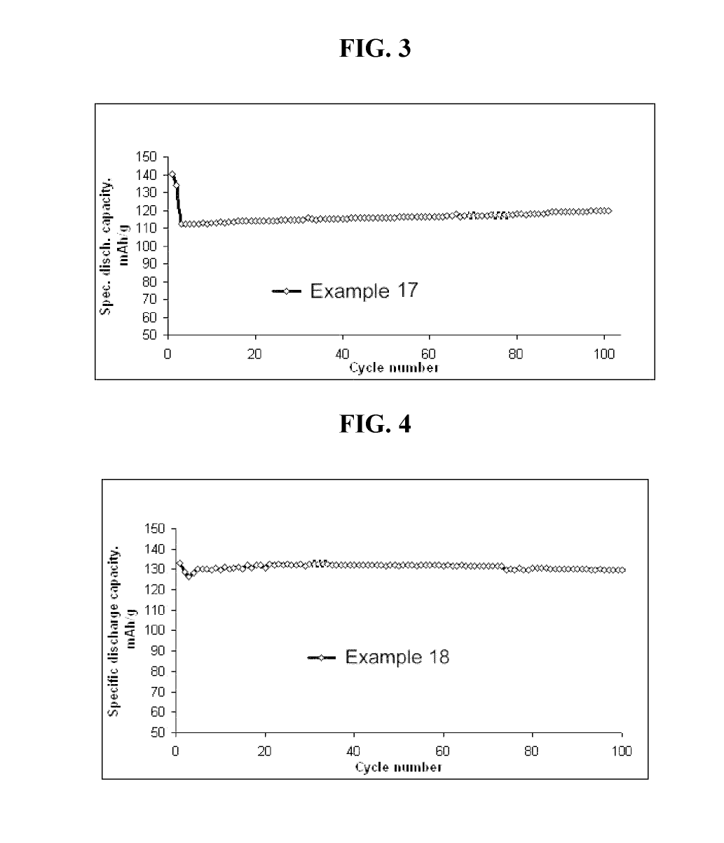

Also, as shown in FIG. 3, the lithium battery of Example 17 showed a stable lifespan characteristic up to the 100^{th} cycle under the same charge/discharge conditions as Evaluation Example 1.

Furthermore, as shown in FIG. 4, the lithium battery of Example 18 showed a stable lifespan characteristic up to the 100^{th} cycle under the same conditions as Evaluation Example 1.

### EVALUATION EXAMPLE 3

### Evaluation of Charge/Discharge Characteristics

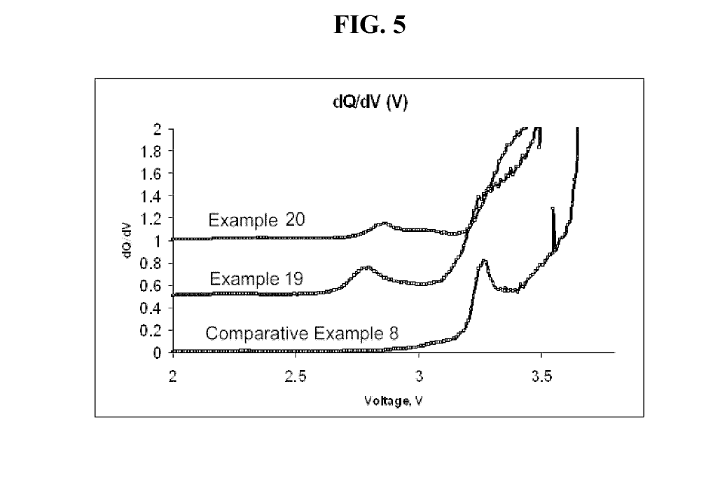

The coin cells manufactured in Examples 19 and 20, and Comparative Example 8 each were charged at constant current of 0.2 C rate at a temperature of 25° C. to a voltage of 4.2 V, and then charged at a constant voltage of 4.2 V to a current of 0.05C (cut-off current), followed by discharging with a constant current of 0.2 C until voltage reached 2.8 V to evaluate initial charge/discharge characteristics. A differential charge/discharge curve in the 1^{st} cycle is shown in FIG. 5.

As shown in FIG. 5, a reduction peak of ethylene carbonate (EC) was shown about 3.2 V in the lithium battery of Comparative Example 8.

The lithium batteries of Examples 19 and 20 showed reduction peaks about 2.7 V due to the formation of SEI and did not show any EC peak about 3.2 V.

These results suggest that the additives in the lithium batteries of Examples 19 and 20 were reduced first at lower voltages and formed modified SEIs, thereby inhibiting a reduction of ethylene carbonate, which is a co-solvent.

As described above, according to the one or more of the above embodiments, an organic electrolyte solution including an ethylene carbonate based additive having a new structure may be used to improve a discharge capacity and a lifespan characteristic of a lithium battery.

It should be understood that the example embodiments described therein should be considered in a descriptive sense only and not for purposes of limitation. Descriptions of features or aspects within each embodiment should typically be considered as available for other similar features or aspects in other embodiments.

What is claimed is:

1. An additive for a lithium battery electrolyte, which is an ethylene carbonate based compound represented by Formula 1 or 2 below: 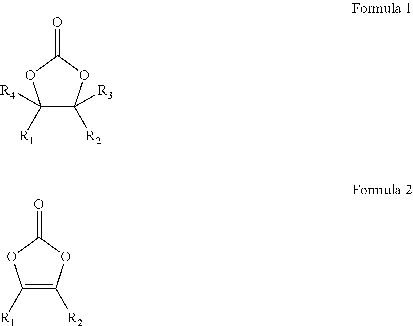
wherein R₁, R₂, R₃, and R₄ are each independently a non-polar functional group or a polar functional group, wherein the polar functional group comprises one or more heteroatoms belonging to groups 13 to 16 of the periodic table of elements, and
wherein one or more of R₁, R₂, R₃, and R₄ are polar functional groups.

2. The additive of claim 1, wherein the polar functional group comprises one or more heteroatoms selected from the group consisting of oxygen, nitrogen, phosphorus, sulfur, silicon, and boron.

3. The additive of claim 1, wherein the polar functional group comprises one or more selected from the group consisting of —C(═O)OR⁹, —OC(═O)R⁹, —OR⁹, —OC(═O)OR⁹, —R⁸OC(═O)OR⁹, —C(═O)R⁹, —R⁸C(═O)R⁹, —OC(═O)R⁹, —R⁸OC(═O)R⁹, —C(═O)—O—C(═O)R⁹, —R⁸C(═O)—O—C(═O)R⁹, —SR⁹, —R⁸SR⁹, —SSR⁸, —R⁸SSR⁹, —S(═O)R⁹, —R⁸S(═O)R⁹, —R⁸C(═S)R⁹, —R⁸C(═S)SR⁹, —R⁸SO₃R⁹, —SO₃R⁹, —NNC(═S)R⁹, —R⁸NNC(═S)R⁹, 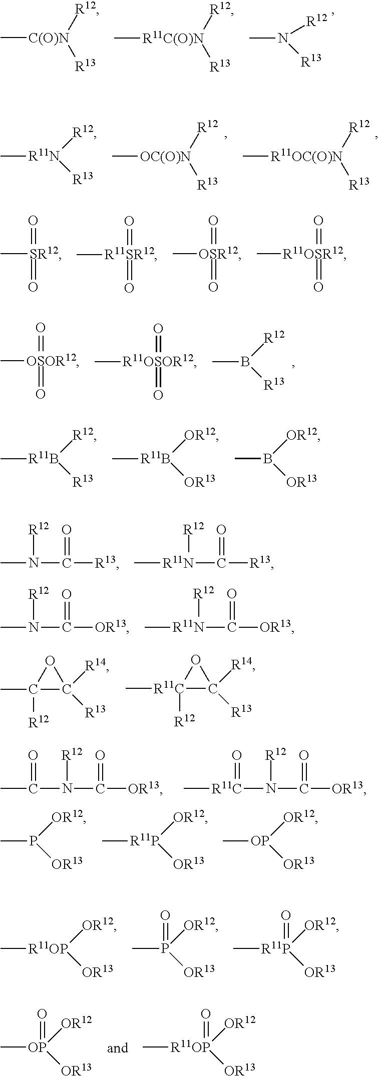
wherein R⁸ and R¹¹ are each independently a C₁-C₂₀ linear or branched alkylene group substituted or unsubstituted with halogen; a C₂-C₂₀ linear or branched alkenylene group substituted or unsubstituted with halogen; an C₂-C₂₀ alkynylene group substituted or unsubstituted with halogen; a C₃-C₁₂ cycloalkylene group substituted or unsubstituted with halogen; a C₆-C₄₀ arylene group substituted or unsubstituted with halogen; or a C₇-C₁₅ aralkylene group substituted or unsubstituted with halogen,
R⁹, R¹², and R¹³ are each independently hydrogen; halogen; a C₁-C₂₀ linear or branched alkyl group substituted or unsubstituted with halogen; a C₂-C₂₀ linear or branched alkenyl group substituted or unsubstituted with halogen; a C₂-C₂₀ alkynyl group substituted or unsubstituted with halogen; a C₃-C₁₂ cycloalkyl group substituted or unsubstituted with halogen; a C₆-C₄₀ aryl group substituted or unsubstituted with halogen; or a C₇-C₁₅ aralkyl group substituted or unsubstituted with halogen, and
k is an integer of 1 to 20.

4. The additive of claim 1, wherein the polar functional group comprises one or more selected from the group consisting of —C(═O)OR¹⁵, —OC(═O)R¹⁵, —OR¹⁵, —OC(═O)OR¹⁵, —R¹⁴OC(═O)OR¹⁵, —C(═O)R¹⁵, —R¹⁴C(═O)R¹⁵, —OC(═O)R¹⁵, —R¹⁴OC(═O)R¹⁵, —C(═O)—O—C(═O)R¹⁵, and —R¹⁴C(═O)—O—C(═O)R¹⁵, wherein
R¹⁴ is a C₂-C₁₀ linear or branched alkylene group substituted or unsubstituted with halogen,
R¹⁵ is hydrogen; halogen; or a C₁-C₁₀ linear or branched alkyl group substituted or unsubstituted with halogen, and
k is an integer of 1 to 20.

5. The additive of claim 1, wherein the ethylene carbonate based compound is represented by the following Formula 3 or 4: 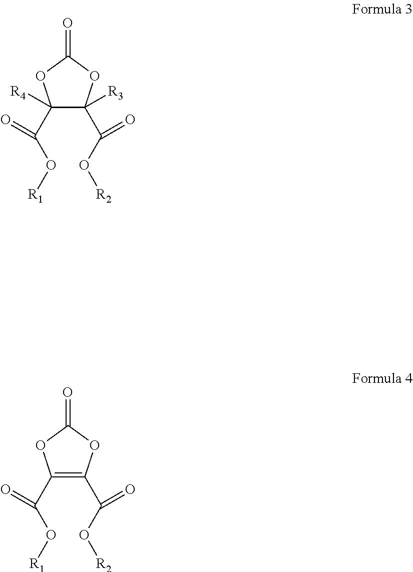
wherein in Formulae 3 and 4, R₁ and R₂ are each independently a C₁-C₁₀ linear or branched alkyl group substituted or unsubstituted with halogen,
wherein in Formulae 3 and 4, R₃ and R₄ are each independently hydrogen; a C₁-C₁₀ linear or branched alkyl group substituted or unsubstituted with halogen; or R₁₆OC(═O)—, and R₁₆ is a C₁-C₁₀ linear or branched alkyl group substituted or unsubstituted with halogen.

6. The additive of claim 1, wherein the ethylene carbonate based compound is represented by one of Formulae 5 to 10:

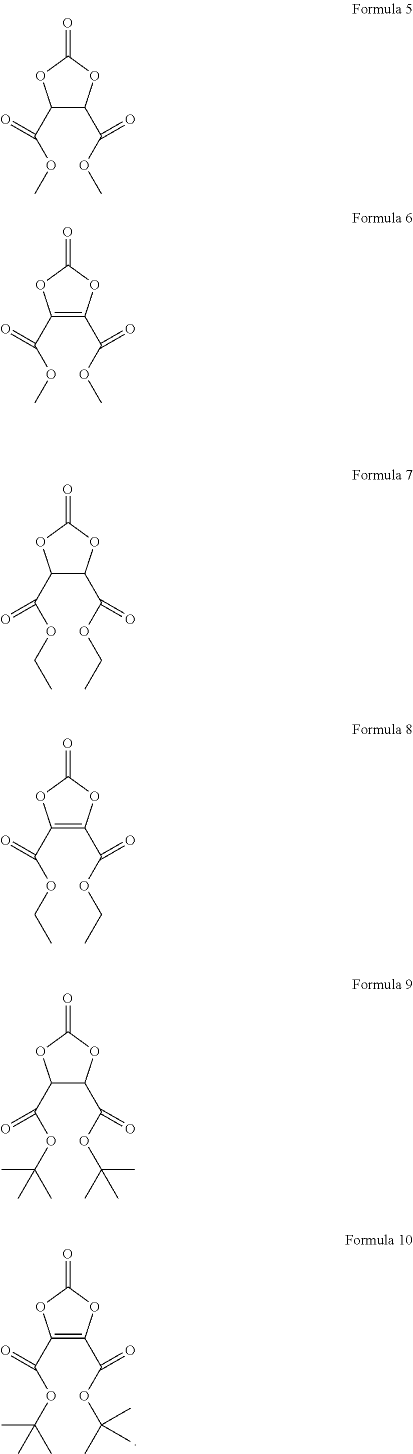

7. An organic electrolyte solution comprising:
a lithium salt;
an organic solvent; and
the additive of claim 1.

8. The organic electrolyte solution of claim 7, wherein the polar functional group comprises one or more heteroatoms selected from the group consisting of oxygen, nitrogen, phosphorus, sulfur, silicon, and boron.

9. The organic electrolyte solution of claim 7, wherein the polar functional group comprises one or more selected from the group consisting of —C(═O)OR⁹, —OC(═O)R⁹, —OR⁹, —OC(═O)OR⁹, —R⁸OC(═O)OR⁹, —C(═O)R⁹, —R⁸C(═O)R⁹, —OC(═O)R⁹, —R⁸OC(═O)R⁹, —C(═O)—O—C(═O)R⁹, —R⁸C(═O)—O—C(═O)R⁹, —SR⁹, —R⁸SR⁹, —SSR⁸, —R⁸SSR⁹, —S(═O)R⁹, —R⁸S(═O)R⁹, —R⁸C(═S)R⁹, —R⁸C(═S)SR⁹, —R⁸SO₃R⁹, —SO₃R⁹, —NNC(═S)R⁹, —R⁸NNC(═S)R⁹, 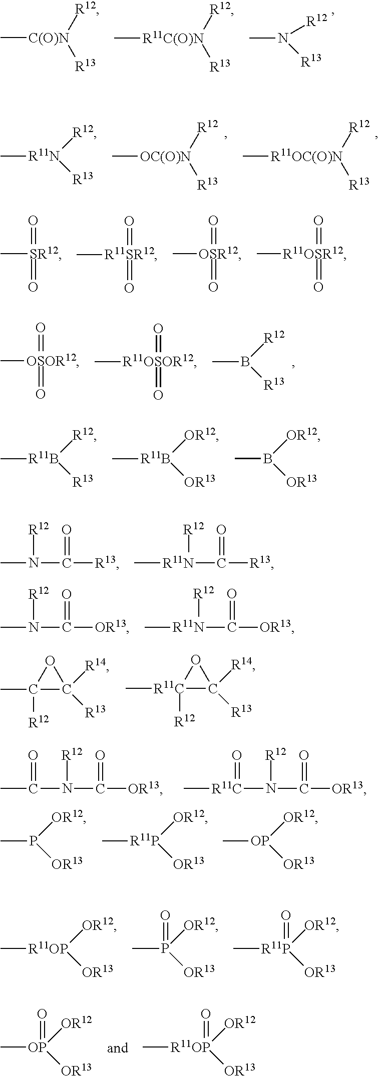
wherein R⁸ and R¹¹ are each independently a C₁-C₂₀ linear or branched alkylene group substituted or unsubstituted with halogen; a C₂-C₂₀ linear or branched alkenylene group substituted or unsubstituted with halogen; an C₂-C₂₀ alkynylene group substituted or unsubstituted with halogen; a C₃-C₁₂ cycloalkylene group substituted or unsubstituted with halogen; a C₆-C₄₀ arylene group substituted or unsubstituted with halogen; or a C₇-C₁₅ aralkylene group substituted or unsubstituted with halogen,
R⁹, R¹², and R¹³ are each independently hydrogen; halogen; a C₁-C₂₀ linear or branched alkyl group substituted or unsubstituted with halogen; a C₂-C₂₀ linear or branched alkenyl group substituted or unsubstituted with halogen; a C₂-C₂₀ alkynyl group substituted or unsubstituted with halogen; a C₃-C₁₂ cycloalkyl group substituted or unsubstituted with halogen; a C₆-C₄₀ aryl group substituted or unsubstituted with halogen; or a C₇-C₁₅ aralkyl group substituted or unsubstituted with halogen, and
k is an integer of 1 to 20.

10. The organic electrolyte solution of claim 7, wherein the polar functional group comprises one or more selected from the group consisting of —C(═O)OR¹⁵, —OC(═O)R¹⁵, —OR¹⁵, —OC(═O)OR¹⁵, —R¹⁴OC(═O)OR¹⁵, —C(═O)R¹⁵, —R¹⁴C(═O)R¹⁵, —OC(═O)R¹⁵, —R¹⁴OC(═O)R¹⁵, —(R¹⁴O)ₖ₋OR¹⁵, —(OR¹⁴)ₖ₋OR¹⁵, —C(═O)—O—C(═O)R¹⁵, and —R¹⁴C(═O)—O—C(═O)R¹⁵, wherein
R¹⁴ is a C₂-C₁₀ linear or branched alkylene group substituted or unsubstituted with halogen,
R¹⁵ is hydrogen; halogen; or a C₁-C₁₀ linear or branched alkyl group substituted or unsubstituted with halogen, and
k is an integer of 1 to 20.

11. The organic electrolyte solution of claim 7, wherein the ethylene carbonate based compound is represented by the following Formula 3 or 4: 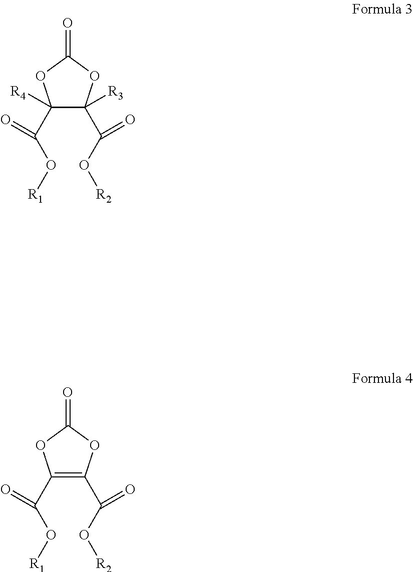
wherein in Formulae 3 and 4, R₁ and R₂ are each independently a C₁-C₁₀ linear or branched alkyl group substituted or unsubstituted with halogen,
wherein in Formulae 3 and 4, R₃ and R₄ are each independently hydrogen; a C₁-C₁₀ linear or branched alkyl group substituted or unsubstituted with halogen; or R₁₆OC(═O)—, and R₁₆ is a C₁-C₁₀ linear or branched alkyl group substituted or unsubstituted with halogen.

12. The organic electrolyte solution of claim 7, wherein the ethylene carbonate based compound is represented by one of Formulae 5 to 10:

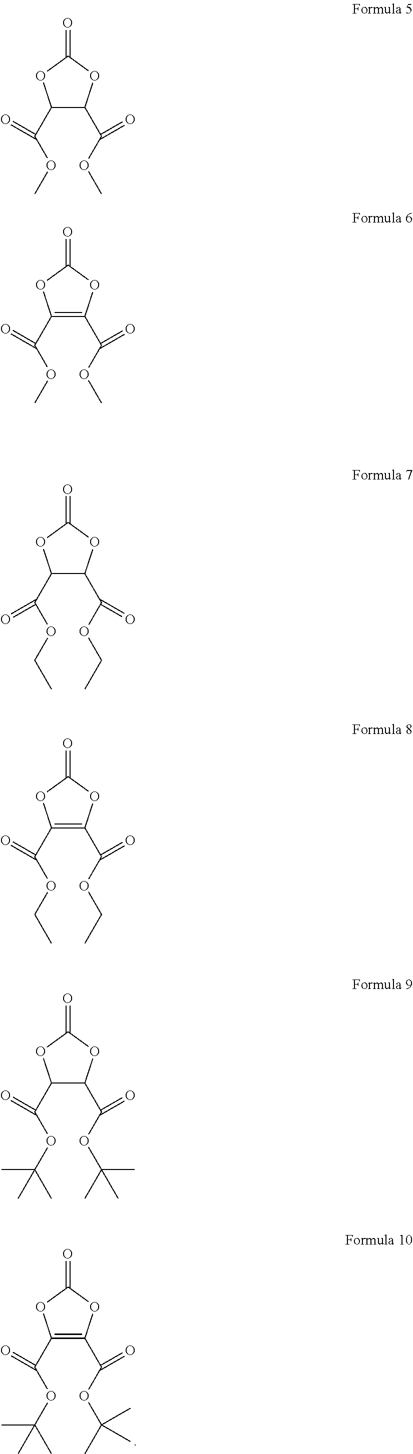

13. The organic electrolyte solution of claim 7, wherein a content of the ethylene carbonate based compound is about 0.1 wt % to about 10 wt % based on a total weight of the organic electrolyte solution.

14. The organic electrolyte solution of claim 7, wherein the organic solvent comprises a low boiling point solvent.

15. The organic electrolyte solution of claim 7, wherein the organic solvent is selected from the group consisting of a dialkyl carbonate, a cyclic carbonate, a linear or cyclic ester, a linear or cyclic amide, an aliphatic nitrile, a linear or cyclic ether, and derivatives thereof.

16. The organic electrolyte solution of claim 14, wherein the organic solvent comprises one or more selected from the group consisting of dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), fluoro-ethylene carbonate (FEC), butylene carbonate, ethyl propionate, ethyl butyrate, acetonitrile, succinonitrile (SN), dimethyl sulfoxide, dimethylformamide, dimethylacetamide, gamma-valerolactone, gamma-butyrolactone, and tetrahydrofuran.

17. The organic electrolyte solution of claim 7, wherein the organic solvent comprises propylene carbonate.

18. The organic electrolyte solution of claim 7, wherein a concentration of the lithium salt in the organic electrolyte solution is about 0.01 M to about 2.0 M.

19. A lithium battery comprising:
a cathode;
an anode; and
the organic electrolyte solution according to claim 7.

20. The lithium battery of claim 19, wherein the anode comprises graphite.
